(19) United States
(12) Patent Application Publication
(10) Pub. No.: US 2020/0383341 A1
(43) Pub. Date: Dec. 10, 2020

(54) MANUFACTURING METHOD FOR DRIED BULBS AND TUBERS HAVING EXCELLENT RESTORABILITY AND PRESERVABILITY AND DRIED BULBS AND TUBERS MANUFACTURED THEREBY

(71) Applicant: WooriDo Co., LTD, Pyeongchang-gun (KR)

(72) Inventors: Jae Young CHO, Pyeongchang-gun (KR); Moo Joong KIM, Gangneung-si (KR); Dong Hwan LEE, Pyeongchang-gun (KR)

(73) Assignee: WooriDo Co., LTD, Pyeongchang-gun (KR)

(21) Appl. No.: 17/001,591

(22) Filed: Aug. 24, 2020

Related U.S. Application Data
(63) Continuation of application No. PCT/KR2018/007246, filed on Jun. 26, 2018.

(30) Foreign Application Priority Data
May 23, 2018 (KR) 10-2018-0058665

(51) Int. Cl. A23B 7/024; A23L 19/10; A23L 5/30; A23B 7/10; A23B 7/01; A23B 7/157; A23L 33/15

(52) U.S. Cl. CPC A23B 7/024; A23L 19/10; A23L 5/32; A23V 2002/00; A23B 7/01; A23B 7/157; A23L 33/15; A23B 7/10

(57) ABSTRACT

The present invention relates to a manufacturing method for dried bulbs and tubers, the method comprising the steps of: punching and perforating the surface of bulbs and tubers with microneedles; placing the perforated bulbs and tubers in a test tube; and freeze-drying the perforated bulbs and tubers placed in the test tube. According to the features of the present invention, the nutritional values of bulbs and tubers can be increased, high-quality products can be provided to a consumer through simple processing, and dried bulbs and tubers having a high restoration rate while having a significantly extended expiration date can be provided.

### CROSS-REFERENCE TO RELATED APPLICATIONS

The present application is a continuation of International Patent Application No. PCT/KR2018/007246, filed on June 26, 2018, which is based upon and claims the benefit of priority to Korean Patent Application No. 10-2018-0058665, filed on May 23, 2018. The disclosures of the above-listed applications are hereby incorporated by reference herein in their entirety.

### TECHNICAL FIELD

The present invention relates to a manufacturing method for bulbs and tubers and dried bulbs and tubers manufactured thereby, and more particularly, to a manufacturing method for bulbs and tubers and dried bulbs and tubers manufactured thereby to increase excellent nutritional values of the bulbs and tubers, provide high-quality products to consumers through simple processing, significantly expand an expiration date, and have a high restoration rate at a fine portion such as rootlets.

### BACKGROUND ART

A wild-simulated ginseng is a general term referring to a semi-wild or semi-cultivated ginseng by artificially sowing a wild ginseng. The wild-simulated ginseng is different from the wild ginseng, and distributed at a price higher than a ginseng.

The wild-simulated ginsengs are distributed in the form of raw wild-simulated ginsengs, dried wild-simulated ginsengs, or dried and powdered wild-simulated ginsengs. The dried wild-simulated ginseng has a significantly deteriorated restoration rate. In addition, since consumers regard that the dried and powdered wild-simulated ginseng is added with various additives during processing, the distribution is not actively carried out. In addition, the raw wild-simulated ginseng has a very short expiration date, thereby causing difficulty to farmers.

According to the conventional schemes, the dried wild-simulated ginseng has difficulty in maintaining an original shape due to the significantly lowered restoration rate particularly for a fine portion such as rootlets, the raw wild-simulated ginseng has a very short expiration date, and the consumers tend to be reluctant with respect to the dried and powdered wild-simulated ginseng. Thus, since there is a limit for industrialization despite the excellent physiological activation function of the wild-simulated ginseng, there are not significant contributions to farm incomes, and it is undesirable in an aspect of national health care. Accordingly, solutions for the above problems are required.

Various bulbs and tubers, such as codonopsis lanceolate, ginseng, and balloon flower root, including the wild-simulated ginseng also have the above problems. Hereinafter, the present invention will be described in the expanded range of bulbs and tubers including the wild-simulated ginseng.

### DISCLOSURE

### Technical Problem

An object of the present invention is to provide a manufacturing method for bulbs and tubers and dried bulbs and tubers manufactured thereby to increase excellent nutritional values of bulbs and tubers including wild-simulated ginseng, provide high-quality products to consumers through simple processing, significantly expand an expiration date, and have a high restoration rate of a fine portion such as rootlets.

### Technical Solution

The above-described technical problem of the present invention is achieved by the following subject matter.

(1) A manufacturing method for dried bulbs and tubers, which includes the steps of:

punching and perforating a surface of bulbs and tubers using a microneedle; placing the perforated bulbs and tubers in a test tube; and freeze-drying the perforated bulbs and tubers placed in the test tube.

(2) The manufacturing method for dried bulbs and tubers in the above (1), wherein

the bulbs and tubers are freezed at −40° C. or less, and dried while maintaining a vacuum state at 10 torr or less in a vacuum freeze-drying apparatus.

(3) The manufacturing method for dried bulbs and tubers in the above (1), wherein the bulbs and tubers include wild-simulated ginseng.

(4) The manufacturing method for dried bulbs and tubers in the above (1), which further includes the steps of:

performing a pre-treatment process including primarily washing the bulbs and tubers using water, and secondarily washing the bulbs and tubers by irradiating a surface of the bulbs and tubers with ultrasonic waves for 10 to 60 minutes using an ultrasonic generator in a range between 20 kHz to 90 kHz; and

primarily sterilizing a surface of the washed bulbs and tubers using subacid electrolysis water of pH 5 to pH 7, and secondarily sequentially performing ultraviolet sterilization or/and chemical sterilization.

(5) The manufacturing method for dried bulbs and tubers in the above (1), which further includes the step of:

punching the bulbs and tubers after immersing the microneedle in alkaline-reduced water containing 0.1 wt % to 5 wt % of vitamin C, before punching using the microneedle.

(6) Bulbs and tubers manufactured by the method according to any one selected among the above (1) to (5).

### Advantageous Effects

The present invention can provide bulbs and tubers in which excellent nutritional values of the bulbs and tubers can be increased, high-quality products can be provided to consumers through simple processing, an expiration date can be significantly expanded, and a high restoration rate of a fine portion such as rootlets can be improved.

### DESCRIPTION OF DRAWINGS

FIG. 1 is a view showing a manufacturing process of bulbs and tubers according to the present invention.

FIG. 2 is a view illustrating a configuration of a bulb inserted to a test tube as an example according to the present invention.

FIGS. 3 to 5 are experiment figures according to the examples of the present invention.

### DETAILED DESCRIPTIONS

The technical terms used in the present invention, unless otherwise defined, are used to have the same meanings as commonly understood by a person having ordinary skill in the art. In addition, a preferable scheme or specimen may be described in the specification herein, and the items similar or equivalent thereto also may be included in the scope of the present invention.

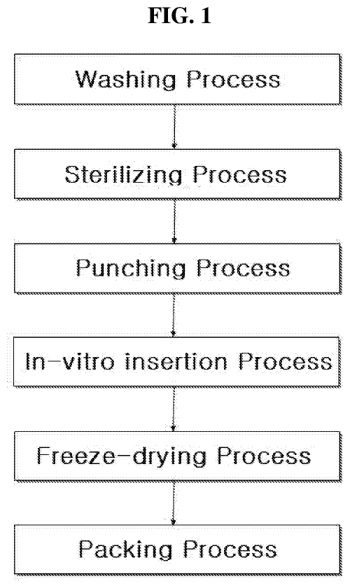

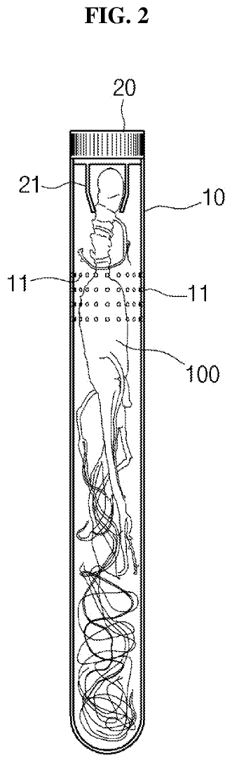

Hereinafter, the present invention will be described according to manufacturing process in more detail as follows with reference to FIGS. 1 and 2.

In the present invention, the bulbs and tubers are not particularly limited, include bulbs and tubers such as wild-simulated ginseng, codonopsis lanceolata, ginseng, and balloon flower root, and preferably include wild-simulated ginseng or ginseng.

The manufacturing process of the dried bulbs and tubers according to the present invention, as shown in FIG. 1, includes a washing step, a sterilization step, a punching step, an in-vitro insertion step, freeze-drying step, and a packaging step.

According to the present invention, the washing step may be preferably performed in two steps of primarily washing the bulbs and tubers using water, and then washing impurities on the surface using ultrasonic waves. For ultrasonic washing, a method of irradiating the surface of the bulbs and tubers with the ultrasonic waves for 10 to 60 minutes using an ultrasonic generator in a range between 20 kHz to 90 kHz may be used, but it is not limited thereto.

In the sterilization step, it is preferable to primarily perform surface sterilization of the washed bulbs and tubers using acid electrolysis water, and secondarily sequentially perform ultraviolet sterilization or/and chemical sterilization.

It is sufficient that the acidic electrolysis water is obtained by a known scheme and may include, for example, subacid electrolyzed water, in which sterilizing and disinfecting power is excellent since chlorine is present in the form of 99% of HClO and 1% of ClO— in the range of pH 5 to pH 7.

In addition, it is sufficient to irradiate the surface of bulbs with ultraviolet rays of 200 nm to 400 nm for 10 minutes to 60 minutes for the ultraviolet sterilization. For the chemical sterilization, sodium hypochlorite, fermented alcohol, and the like, for example, may be used as a disinfectant safely used in food.

When the sterilization process is completed as described above, the punching process is performed. To this end, a microneedle having a thickness of the needle in the range of about 20 gauge to about 60 gauge, though it is not limited thereto, may be used. According to the method of punching the surface of the bulbs and tubers using the microneedle, the surface may be perforated by punching manually using the microneedle, or the surface may be punched in large quantities at once using mechanical equipment such as needle punching machine, in which it is preferable to form a plurality of punchings on the surface of the bulbs and tubers at regular intervals.

Preferably, when the bulbs and tubers are punched after the microneedle is immersed in alkaline-reduced water containing 0.1 wt % to 5 wt % of vitamin C before the punching is preformed using the microneedle, a dual effect may be provided in which the bulbs and tubers fortified with vitamin C ingredient may be obtained and a browning phenomenon inside the bulbs and tubers due to the punching may be prevented.

When the punching process is completed, the bulb 100 perforated as in the above manner is inserted and fixed to an inside of a test tube 10 having an inner diameter similar to an outer diameter of the bulb, as shown in FIG. 2. A separate device for fixing the bulb to the inside of the test tube is not required. However, when a test tube having a relatively large diameter is required, it is preferable to install an auxiliary fixing cap 20 at an upper end portion of the test tube to fix an upper end of the bulb by using a fixing member 21, as shown in FIG. 2.

Preferably, the test tube may be perforated (11) at regular intervals so as to effectively perform the subsequent freeze-drying process while ensuring air-permeability.

The freeze-drying of the bulbs is performed after the bulbs perforated and fixed in the above manner are put in a vacuum freeze-drying apparatus together with the test tubes. Preferably, the freeze-drying process may be performed while maintaining a vacuum of 1 torr to 10 torr and a temperature of −70° C. to −40° C. When the freeze-drying is performed under the above conditions for the bulbs and tubers punched as described above, the shape may be prevented from being distorted or the color may be prevented from being discolored even when moisture is removed, and fine rootlets may remain unchanged without a separation or a deformation of original shape, thereby remarkably improving the marketability.

When the freeze-drying is completed, packaging may be performed while being contained in the test tube. In this case, the volume required for the packaging may be significantly reduced, so that transportation costs may also be reduced. Thus, a price competitiveness in exports is improved and enables occupying a very advantageous position over products of other competitive countries.

Further, the dried bulbs and tubers manufactured according to the present invention may be ingested, after separated from the test tube and put and soaked in mineral water or various beverage such as alcohol in a dried state.

The dried bulbs and tubers according to the invention as above can provide excellent restoration or preservation even one year later, without changes in taste and color while maintaining the original shape even at the fine portion such as rootlets (especially, when the dried bulbs are put in a liquid such as drinking water or alcohol, the rootlets spreads out into the original state and restores the original shape as the liquid is permeated into the rootlets), so that the dried bulbs can be supplied throughout the year, and consumers can purchase high-quality products any time without worry about the supply.

Hereinafter, the present invention will be described in more detail with reference to Examples. However, the following exemplary Examples are merely proposed for further understandings of the present invention and should not be construed as limiting the scope of the present invention.

### EXAMPLE 1

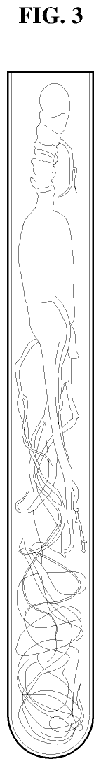

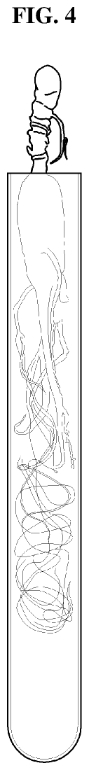

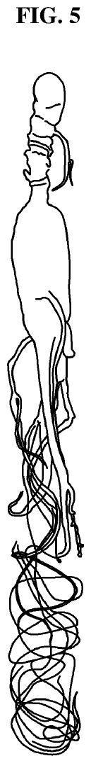

The wild-simulated ginseng was primarily washed using running water and then impurities on a surface were removed by treating the surface using ultrasonic waves of 40 kHz for 30 minutes. Then, the surface of the wild-simulated ginseng was sterilized using subacid electrolysis water of pH 5.5 (chlorine was present as 99% of HClO and 1% of ClO—), and subsequently, ultraviolet sterilization (200 nm, 10 minutes) and chemical sterilization (sodium hypochlorite) were sequentially processed. The wild-simulated ginseng was punched to form a plurality of micro-pores manually or by using needle punching machine mounted with a 30-gauge microneedle at an upper portion thereof. The wild-simulated ginseng punched by the microneedle was placed in a test tube having a diameter for allowing the wild-simulated ginseng to be fixed therein, and was put in a vacuum freeze-drying apparatus while being put in the test tube, and a drying process was performed while maintaining a temperature of −40° C. and a vacuum of 10 torr (see FIGS. 3 to 5). The freeze-dried wild-simulated ginsengs were packed by the 20 pieces while being put in test tubes, respectively.

### EXAMPLE 2

A codonopsis lanceolata was primarily washed using running water and then impurities on a surface were removed by treating the surface using ultrasonic waves of 40 kHz for 30 minutes. Then, the surface of the codonopsis lanceolata was sterilized using subacid electrolysis water of pH 5.5 (chlorine was present as 99% of HClO and 1% of ClO—), and subsequently, ultraviolet sterilization (200 nm, 10 minutes) and chemical sterilization (sodium hypochlorite) were sequentially processed. The wild-simulated ginseng was punched to form a plurality of micro-pores manually or by using needle punching machine mounted with a 30-gauge microneedle at an upper portion thereof. The wild-simulated ginseng punched by the microneedle was placed in a test tube having a diameter for allowing the wild-simulated ginseng to be fixed therein, and was put in a vacuum freeze-drying apparatus while being put in the test tube, and a drying process was performed while maintaining a temperature of −40° C. and a vacuum of 10 torr. The freeze-dried wild-simulated ginsengs were packed by the 20 pieces while being put in test tubes, respectively.

### EXAMPLE 3

A six-year-old ginseng was primarily washed using running water and then impurities on a surface were removed by treating the surface using ultrasonic waves of 40 kHz for 30 minutes. Then, the surface of the ginseng was sterilized using subacid electrolysis water of pH 5.5 (chlorine was present as 99% of HClO and 1% of ClO—), and subsequently, ultraviolet sterilization (200 nm, 10 minutes) and chemical sterilization (sodium hypochlorite) were sequentially processed. The wild-simulated ginseng was punched to form a plurality of micro-pores manually or by using needle punching machine mounted with a 30-gauge microneedle at an upper portion thereof. The wild-simulated ginseng punched by the microneedle was placed in a test tube having a diameter for allowing the wild-simulated ginseng to be fixed therein, and was put in a vacuum freeze-drying apparatus while being put in the test tube, and a drying process was performed while maintaining a temperature of −40° C. and a vacuum of 10 torr. The freeze-dried wild-simulated ginsengs were packed by the 20 pieces while being put in test tubes, respectively.

### EXAMPLE 4

A balloon flower root was primarily washed using running water and then impurities on a surface were removed by treating the surface using ultrasonic waves of 40 kHz for 30 minutes. Then, the surface of the balloon flower root was sterilized using subacid electrolysis water of pH 5.5 (chlorine was present as 99% of HClO and 1% of ClO—), and subsequently, ultraviolet sterilization (200 nm, 10 minutes) and chemical sterilization (sodium hypochlorite) were sequentially processed. The balloon flower root was punched to form a plurality of micro-pores manually or by using needle punching machine mounted with a 30-gauge microneedle at an upper portion thereof. The wild-simulated ginseng punched by the microneedle was placed in a test tube having a diameter for allowing the wild-simulated ginseng to be fixed therein, and was put in a vacuum freeze-drying apparatus while being put in the test tube, and a drying process was performed while maintaining a temperature of −40° C. and a vacuum of 10 torr. The freeze-dried wild-simulated ginsengs were packed by the 20 pieces while being put in test tubes, respectively.

### EXAMPLE 5

The dried bulbs were manufactured in the same manner as in Example 1 except that the microneedle was immersed in alkaline reduced water containing vitamin C (1 wt %) prior to the needle punching.

### EXPERIMENTAL EXAMPLE 1

### Quality Properties

As the following Table 1 shows the results of comparing the dried bulbs manufactured by the Examples with frozen bulbs (Comparative Example) that were not put in test tubes, original shapes of the bulbs according to the embodiments of the present invention were maintained even at rootlets after dried, but an original shape of the wild-simulated ginseng of the comparative example was not properly maintained since shapes of rootlets were partially distorted. Thus, it is confirmed that the drying method according to the present invention is a method capable of increasing the restoration rate for the fine portion such as rootlets and remarkably increasing the expiration date.

TABLE 1

| | Example 1 | Example 2 | Example 3 | Example 4 | Example 5 |
|---|---|---|---|---|---|
| Maintenance in | Maintained | Maintained | Maintained | Maintained | Maintained |
| original shapes | | | | | |
| of rootlets | | | | | |
| Preservability | No change | No change | No change | No change | No change |
| | in taste and | in taste and | in taste and | in taste and | in taste and |
| | color even 1 | color even 1 | color even 1 | color even 1 | color even 1 |
| | year later | year later | year later | year later | year later |

| | | |
|---|---|---|
| | Comparative Example | Remarks |
| Maintenance in | Partially twisted | In Examples 1 to 4, a slight |
| original shapes | | browning phenomenon was observed |
| of rootlets | | at the punched inside 1 year later, |
| Preservability | No change in taste and | but in Example 5, the browning |
| | color even 1 year later | was not observed inside at all. |

Although the present invention has been described with reference to the exemplary embodiments as above, it will be apparent to those skilled in the art that various modifications and variations can be made in the present invention without departing from the scope and the field of the following appended claims.

[Description of
Reference Numerals]
10: Test tube
11: Perforated portion
20: Auxiliary fixing cap
21: fixing member

What is claimed is:

1. A method for manufacturing dried bulbs and tubers, the method comprising:
punching and perforating a surface of bulbs and tubers using a microneedle;
placing the perforated bulbs and tubers in a test tube; and
freeze-drying the perforated bulbs and tubers placed in the test tube.

2. The method of claim 1, wherein the bulbs and tubers are freezed at −40° C. or less, and dried while maintaining a vacuum state at 10 torr or less in a vacuum freeze-drying device.

3. The method of claim 1, wherein the bulbs and tubers include wild-simulated ginseng, codonopsis lanceolata, ginseng, or balloon flower root.

4. The method of claim 1, further comprising:
performing a pre-treatment process including
primarily washing the bulbs and tubers using water, and secondarily washing the bulbs and tubers by irradiating a surface of the bulbs and tubers with ultrasonic waves for 10 to 60 minutes using an ultrasonic generator in a range between 20 kHz to 90 kHz; and
primarily sterilizing a surface of the washed bulbs and tubers using subacid electrolysis water of pH 5 to pH 7, and secondarily performing ultraviolet sterilization or/and chemical sterilization sequentially.

5. The method of claim 1, further comprising:
punching the bulbs and tubers after immersing the microneedle in alkaline-reduced water containing 0.1 wt % to 5 wt % of vitamin C, before punching using the microneedle.

6. Dried bulbs and tubers manufactured by the method according to claim 1.
